(19) United States
(12) Patent Application Publication
(10) Pub. No.: US 2021/0179186 A1
(43) Pub. Date: Jun. 17, 2021

(54) VEHICLE REAR STRUCTURE

(71) Applicants: HYUNDAI MOTOR COMPANY, Seoul (KR); KIA MOTORS CORPORATION, Seoul (KR)

(72) Inventors: Seung Chan CHOI, Seoul (KR); Da Mi BOK, Hwaseong-si (KR); Seung Hyun KANG, Suwon-si (KR)

(21) Appl. No.: 17/019,580

(22) Filed: Sep. 14, 2020

(30) Foreign Application Priority Data
Dec. 13, 2019 (KR) 10-2019-0167081

(51) Int. Cl. B62D 25/08

(52) U.S. Cl. CPC B62D 25/087; B62D 25/06

(57) ABSTRACT

A vehicle rear structure includes: a back frame having a top portion, a bottom portion, a pair of side portions, and a pair of upper corners located on both ends of the top portion, respectively, to define a back opening; and a first reinforcing member extending from each upper corner along a corresponding side portion, wherein the first reinforcing member includes a reinforcing bead and a peripheral flange extending along an edge of the reinforcing bead, and the peripheral flange is configured to be connected to the corresponding side portion of the back frame.

### CROSS-REFERENCE TO RELATED APPLICATION

This application is based on and claims the benefit of priority to Korean Patent Application No. 10-2019-0167081, filed on Dec. 13, 2019, in the Korean Intellectual Property Office, the disclosure of which is incorporated herein in its entirety by reference.

### TECHNICAL FIELD

The present disclosure relates to a vehicle rear structure, and more particularly, to a vehicle rear structure capable of improving stiffness with respect to a back frame defining a back opening of a vehicle.

### BACKGROUND

In general, a vehicle has a back opening communicating with a luggage compartment or rear compartment in which luggage and the like can be stored. A back door, such as a hatchback door, a trunk lid, a tailgate, or a liftgate, may be installed in the back opening in a manner that opens and closes the back opening.

A vehicle body includes a back frame defining the back opening, and the back frame may be defined by a rear edge of a roof panel, rear edges of a pair of side structures, and a top edge of a back panel.

When stiffness of the back frame is reduced, vehicle noise may become severe. For example, vehicles with relatively large luggage compartment space, such as hatchback vehicles and wagon vehicles, may suffer from noise due to torsional vibration of the vehicle body. Specifically, the torsional vibration occurs in the power train's operating range of 1100 to 1300 rpm, and the torsional vibration excites the vehicle body and the back door through a drive shaft, a lower arm, etc., resulting in lock-up booming noise (in automatic transmission vehicles), high-stage low-speed booming noise (in manual transmission vehicles), etc. Here, the vehicle body becomes a transfer system of noise, and the vibration transferred to the back frame and the back door (e.g. a hatchback door, a trunk lid, a tailgate, a liftgate, etc.) may be reduced when a torsional natural frequency of the vehicle body is high. Thus, increasing the torsional natural frequency of the vehicle body is an important consideration in vehicle body design.

The following method to increase the torsional natural frequency of the vehicle body as well as improving the stiffness of the back frame has been suggested: a reinforcing member extends straightly from a top end of the back frame toward a wheel housing, and the reinforcing member directly connects the top end of the back frame and the wheel housing.

However, such an existing method may increase the weight of the vehicle body, and have a limitation in increasing the torsional natural frequency of the vehicle body or reducing the booming noise.

The above information described in this background section is provided to assist in understanding the background of the inventive concept, and may include any technical concept which is not considered as the prior art that is already known to those skilled in the art.

### SUMMARY

The present disclosure has been made to solve the above-mentioned problems occurring in the prior art while advantages achieved by the prior art are maintained intact.

An aspect of the present disclosure provides a vehicle rear structure capable of improving stiffness with respect to a back frame defining a back opening of a vehicle.

According to an aspect of the present disclosure, a vehicle rear structure may include: a back frame having a top portion, a bottom portion, a pair of side portions, and a pair of upper corners located on both ends of the top portion, respectively, to define a back opening; and a first reinforcing member extending from each upper corner along a corresponding side portion. The first reinforcing member may include a reinforcing bead and a peripheral flange extending along an edge of the reinforcing bead, and the peripheral flange may be configured to be connected to the corresponding side portion of the back frame.

The reinforcing bead may be raised from the peripheral flange, and the reinforcing bead may have a closed cavity.

The first reinforcing member may have a flange joined to each upper corner, the reinforcing bead may extend from the flange, and the first reinforcing member may have a closure wall closing a bottom end of the reinforcing bead.

The vehicle rear structure may further include a roof reinforcing member connected to the upper corner of the back frame, and the flange of the first reinforcing member may be joined to the roof reinforcing member.

A length of the reinforcing bead may be half of a height of the back opening.

The first reinforcing member may be L-shaped.

The first reinforcing member may have an extension flange tightly contacting and connected to a portion of a side structure of a vehicle body, and the extension flange may be connected to the reinforcing bead.

The vehicle rear structure may further include a second reinforcing member extending from the first reinforcing member toward a bottom of a vehicle body, and the second reinforcing member may be connected to the first reinforcing member to intersect at a predetermined angle.

The second reinforcing member may extend from the first reinforcing member to a wheel house of a side structure of the vehicle body.

The second reinforcing member may have an upper flange connected to the first reinforcing member, and a lower flange connected to the wheel house.

The first reinforcing member may further include a matching flange connected to at least a portion of an opening frame of a quarter inner panel in the side structure of the vehicle body, and the opening frame may define a quarter opening of the quarter inner panel.

The upper flange of the second reinforcing member may be connected to the first reinforcing member and the opening frame of the quarter inner panel.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a perspective view of a vehicle rear structure according to an exemplary embodiment of the present disclosure;

FIG. 2 illustrates an enlarged view of an upper corner of a back frame and a side portion connected thereto in the vehicle rear structure of FIG. 1;

FIG. 3 illustrates an enlarged view of portion A of FIG. 2;

FIG. 4 illustrates a perspective view which is viewed in a direction indicated by arrow B of FIG. 2;

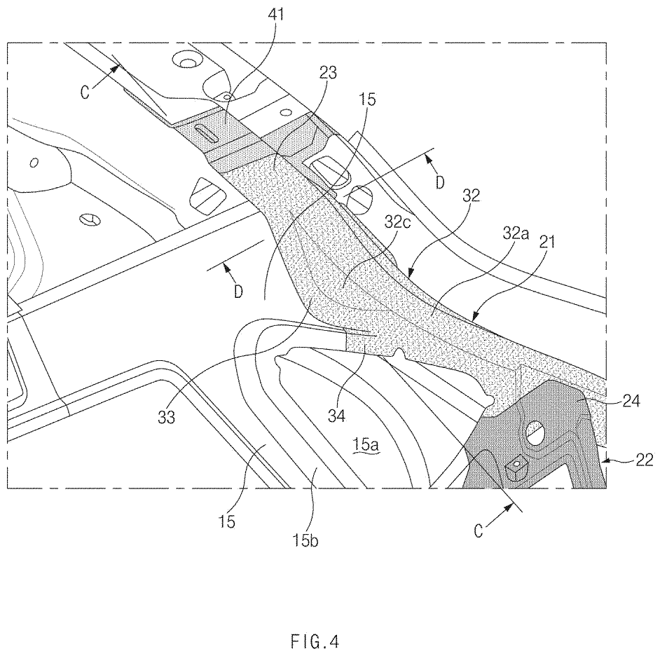

FIG. 5 illustrates a cross-sectional view taken along line C-C of FIG. 4; and

FIG. 6 illustrates a cross-sectional view taken along line D-D of FIG. 4.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

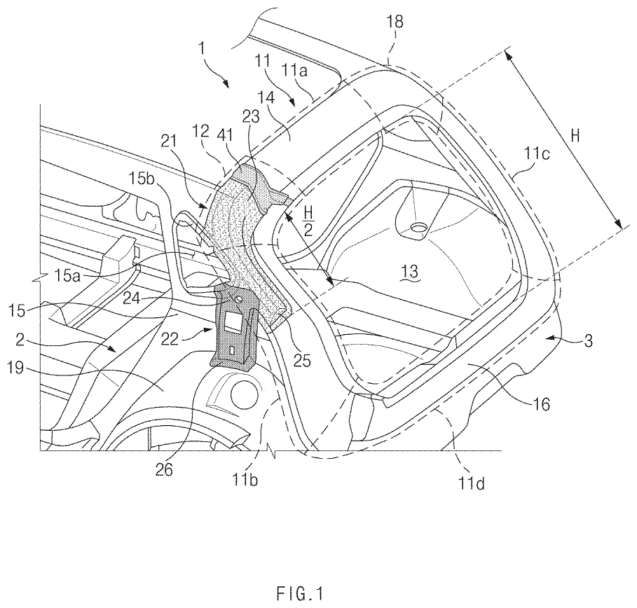

Referring to FIG. 1, a vehicle rear structure according to an exemplary embodiment of the present disclosure may include a back frame 11 defining a back opening 13. The back frame 11 may be defined by a top structure 1, a pair of side structures 2, and a back structure 3. In particular, the back frame 11 may be defined by a rear edge of the top structure 1, rear edges of the pair of side structures 2, and a top edge of the back structure 3. The back opening 13 may communicate with a luggage compartment or rear compartment in which luggage and the like are received, and a back door such as a hatchback door, a trunk lid, a tailgate, or a liftgate may be installed in the back opening 13 in a manner that opens and closes the back opening 13.

According to an exemplary embodiment, the top structure 1 may include a roof panel (not shown) and a rear roof rail 14 connected to a rear edge of the roof panel. Each side structure 2 may include a quarter inner panel 15 and a side outer panel (not shown) covering the quarter inner panel 15. The back structure 3 may include an inner back panel 16 connected to a lower portion of the quarter inner panel 15 and an outer back panel (not shown) covering the inner back panel 16.

The quarter inner panel 15 may have a quarter opening 15a in which quarter glass is mounted, and an opening frame 15b defining the quarter opening 15a. The opening frame 15b may be raised from an exterior surface of the quarter inner panel 15 toward the exterior of the vehicle, and the raised opening frame 15b may increase stiffness of the quarter inner panel 15. A wheel house 19 protecting a wheel may be integrally connected to the lower portion of the quarter inner panel 15. For example, the quarter inner panel 15 may be divided into an upper panel and a lower panel, and the inner back panel 16 may be integrally connected to the lower panel.

The back frame 11 may have a top portion 11a, a pair of side portions 11b and 11c, a bottom portion 11d, and a pair of upper corners 12 and 18 located on both ends of the top portion 11a, respectively. The top portion 11a may be defined in a longitudinal direction of the rear roof rail 14. The side portions 11b and 11c may be defined along the rear edges of the side structures 2, respectively. The bottom portion 11d may be defined along the top edge of the back structure 3. Each end portion of the rear roof rail 14 and a top end of each quarter inner panel 15 may be connected so that each of the upper corners 12 and 18 may be defined by the end portion of the rear roof rail 14 and the top end of the quarter inner panel 15. Each of the upper corners 12 and 18 and each of the side portions 11b and 11c in the back frame 11 may be reinforced by a first reinforcing member 21 and a second reinforcing member 22. FIG. 1 illustrates the first reinforcing member 21 and the second reinforcing member 22 which are mounted on the left upper corner 12 and the left side portion 11b, but the first reinforcing member 21 and the second reinforcing member 22 may also be mounted on the right upper corner 18 and the right side portion 11c in the same manner.

The first reinforcing member 21 may extend from each of the upper corners 12 and 18 along the corresponding side portions 11b and 11c, and the first reinforcing member 21 may be L-shaped. The end portions of the rear roof rail 14 may be located on the upper corners 12 and 18 of the back frame 11, respectively, and thus each end portion of the rear roof rail 14 may form a portion of each upper corner of the back frame 11, respectively. Specifically, the first reinforcing member 21 may extend from each end portion of the rear roof rail 14 along a rear edge of the quarter inner panel 15.

The first reinforcing member 21 may have a flange 23 extending from a top end thereof, and the flange 23 may be joined to each upper corner of the back frame 11 by welding and/or the like.

A roof reinforcing member 41 may be connected to each upper corner of the back frame 11. In particular, the roof reinforcing member 41 may be connected to the rear edge of the top structure 1. Specifically, the roof reinforcing member 41 may be joined to each end portion of the rear roof rail 14 by welding and/or the like, thereby increasing stiffness of the rear roof rail 14 as well as connecting the end portion of the rear roof rail 14 and the top end of the quarter inner panel 15. The flange 23 of the first reinforcing member 21 may be overlapped and joined to at least a portion of the roof reinforcing member 41. At least a portion of the roof reinforcing member 41 may be interposed between the flange 23 of the first reinforcing member 21 and the rear roof rail 14 so that stiffness of the upper corners 12 and 18 of the back frame 11 may be improved.

The first reinforcing member 21 may have a peripheral flange 31 joined to the rear edge of the quarter inner panel 15 (that is, the side portions 11b and 11c of the back frame 11), and a reinforcing bead 32 raised from the peripheral flange 31 toward the exterior of the vehicle. The peripheral flange 31 may surround the reinforcing bead 32 along the edge of the first reinforcing member 21. The peripheral flange 31 may extend flat so that it may be joined to the rear edge of the quarter inner panel 15.

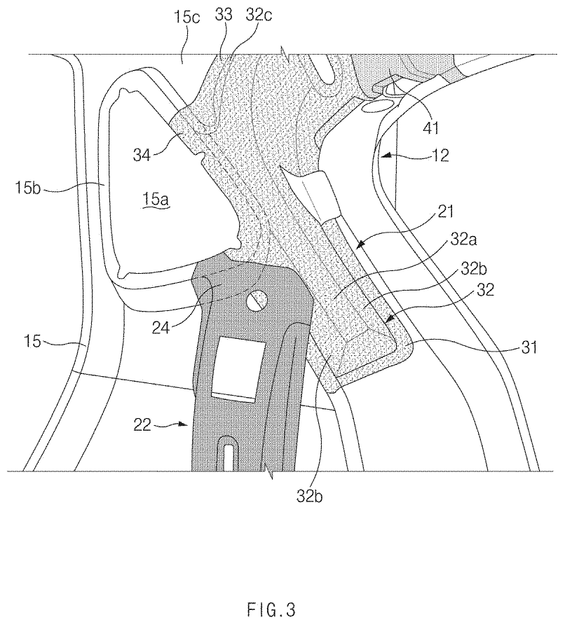

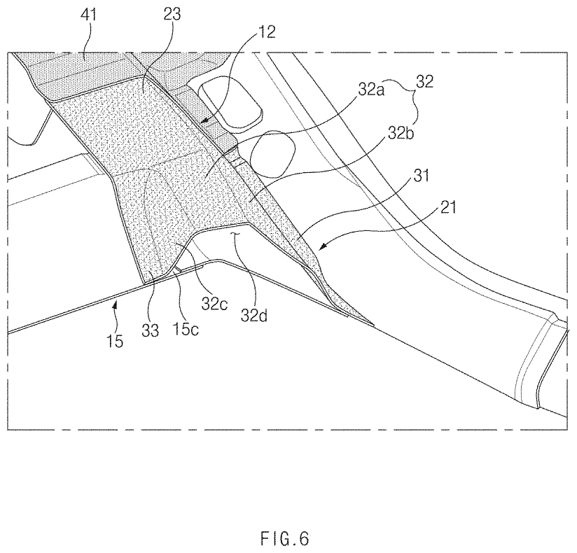

Referring to FIGS. 3 and 6, the reinforcing bead 32 may have a flat surface 32a and an inclined surface 32b extending obliquely from the peripheral flange 31 toward the flat surface 32a, and thus the reinforcing bead 32 may have a cavity 32d therein. The first reinforcing member 21 may have a closure wall 25 closing a bottom end of the reinforcing bead 32, and the peripheral flange 31 may be joined to the quarter inner panel 15 so that the cavity 32d of the reinforcing bead 32 may be a closed cavity which is completely closed with respect to the outside by the closure wall 25. The first reinforcing member 21 may increase stiffness with respect to each of the upper corners 12 and 18 and each of the side portions 11b and 11c of the back frame 11 using the reinforcing bead 32.

The first reinforcing member 21 may include an extension flange 33 tightly joined to the exterior surface of the quarter inner panel 15. The extension flange 33 may extend from the flange 23 and the reinforcing bead 32 of the first reinforcing member 21 toward the opening frame 15b of the quarter inner panel 15. In addition, the extension flange 33 may be connected by the flat surface 32a of the reinforcing bead 32 and a connection wall 32c. The extension flange 33 may be joined to an upper exterior surface 15c of the quarter inner panel 15 by welding and/or the like.

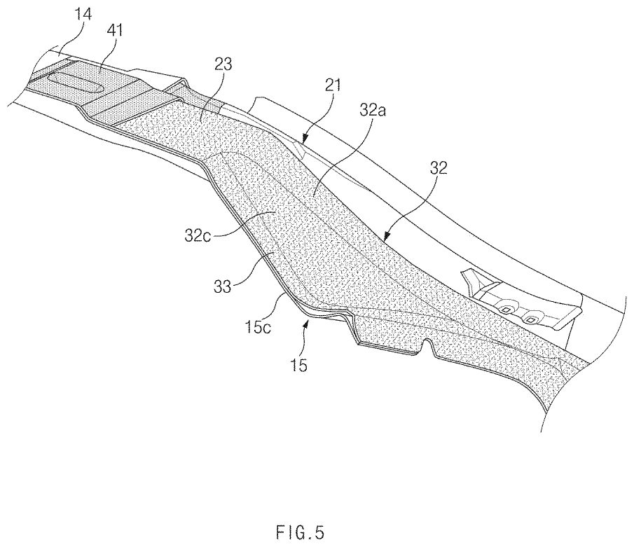

Referring to FIGS. 5 and 6, the extension flange 33 may have a surface that matches the upper exterior surface 15c of the quarter inner panel 15 so that the extension flange 33 and the upper exterior surface 15c of the quarter inner panel 15 may tightly contact and be joined.

The first reinforcing member 21 may further include a matching flange 34 connected to at least a portion of the opening frame 15b of the quarter inner panel 15. The matching flange 34 may be integrally connected to the extension flange 33, and the matching flange 34 may have a cross section matching that of the opening frame 15b.

The reinforcing bead 32 of the first reinforcing member 21 may extend from the flange 23 by a predetermined length. The length of the reinforcing bead 32 may be half (H/2) of a total height H of the back opening 13. That is, the first reinforcing member 21 may be attached to upper areas of the side portions 11b and 11c of the back frame 11, thereby improving support stiffness and torsional stiffness with respect to the upper corners 12 and 18 and the side portions 11b and 11c of the back frame 11.

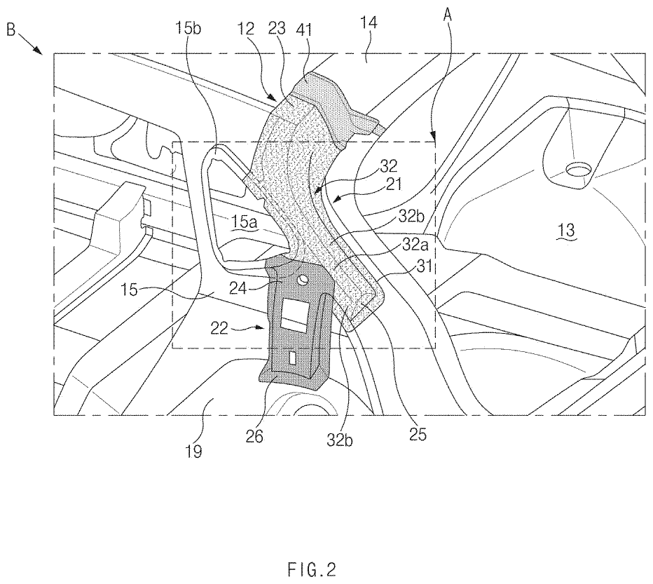

Referring to FIGS. 1 and 2, the second reinforcing member 22 may extend from the first reinforcing member 21 toward the bottom of the vehicle body. The second reinforcing member 22 may intersect with the first reinforcing member 21 at a predetermined angle, and the second reinforcing member 22 may be joined to each side structure 2 by welding and/or the like.

Referring to FIGS. 1 and 2, the second reinforcing member 22 may extend from the first reinforcing member 21 to the wheel house 19 integrally formed with the lower portion of the quarter inner panel 15. The second reinforcing member 22 may be disposed to intersect with each of the side portions 11b and 11c of the back frame 11 at a predetermined angle, thereby firmly supporting each of the side portions 11b and 11c of the back frame 11. Specifically, the second reinforcing member 22 may intersect with the reinforcing bead 32 of the first reinforcing member 21 at a predetermined angle, and the first reinforcing member 21 may be connected to the quarter inner panel 15 and the wheel house 19 of the side structure 2 of the vehicle body by the second reinforcing member 22, whereby the support stiffness and torsional stiffness of the upper corners 12 and 18 and the side portions 11b and 11c of the back frame 11 may be significantly improved.

Referring to FIGS. 1 and 2, the second reinforcing member 22 may have an upper flange 24 connected to the first reinforcing member 21 and a lower flange 26 connected to the wheel house 19. Referring to FIG. 3, the upper flange 24 of the second reinforcing member 22 may be connected to the first reinforcing member 21 and the opening frame 15b of the quarter inner panel 15 adjacent thereto. As the second reinforcing member 22 connects the first reinforcing member 21 and the wheel house 19, a load applied to the upper corner 12 of the back frame 11 may be uniformly distributed.

According to exemplary embodiments of the present disclosure, the first reinforcing member 21 and the second reinforcing member 22 may structurally connect and support the upper corners 12 and 18 and the side portions 11b and 11c of the back frame 11, thereby increasing stiffness with respect to the upper corners 12 and 18 and the side portions 11b and 11c of the back frame 11, and thus improving torsional natural frequency and lock-up booming (high-stage low-speed booming). For example, the torsional natural frequency may be improved by about 5 Hz, and the lock-up booming (high-stage low-speed booming) may be improved by about 6 dB.

According to exemplary embodiments of the present disclosure, by applying a structure in which the second reinforcing member 22 intersects with the first reinforcing member 21 at a predetermined angle, the overall length of the first reinforcing member 21 and the second reinforcing member 22 may be reduced, and thus weight reduction and cost reduction may be achieved.

As set forth above, according to exemplary embodiments of the present disclosure, the upper corners and the side portions of the back frame may be structurally connected and supported by the first reinforcing member and the second reinforcing member, and thus stiffness with respect to the upper corners and the side portions of the back frame may be significantly improved, and the torsional natural frequency and the booming noise reduction may be improved.

According to exemplary embodiments of the present disclosure, the overall length of the first reinforcing member and the second reinforcing member may be reduced, and thus the weight reduction and cost reduction may be achieved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle rear structure, comprising:
a back frame having a top portion, a bottom portion, a pair of side portions, and a pair of upper corners located on both ends of the top portion, respectively, to define a back opening; and
a first reinforcing member extending from each upper corner along a corresponding side portion,
wherein the first reinforcing member includes a reinforcing bead and a peripheral flange extending along an edge of the reinforcing bead, and
wherein the peripheral flange is configured to be connected to the corresponding side portion of the back frame.

2. The vehicle rear structure according to claim 1, wherein the reinforcing bead is configured in a way that the reinforcing bead protrudes from the peripheral flange, and
wherein the reinforcing bead has a closed cavity.

3. The vehicle rear structure according to claim 2, wherein the first reinforcing member has a flange configured to be connected to a corresponding upper corner,
wherein the reinforcing bead extends from the flange, and
wherein the first reinforcing member has a closure wall closing a bottom end of the reinforcing bead.

4. The vehicle rear structure according to claim 3, further comprising a roof reinforcing member connected to the upper corner of the back frame,
wherein the flange of the first reinforcing member is configured to be connected to the roof reinforcing member.

5. The vehicle rear structure according to claim 1, wherein a length of the reinforcing bead is half of a height of the back opening.

6. The vehicle rear structure according to claim 1, wherein the first reinforcing member has an L-shape.

7. The vehicle rear structure according to claim 1, wherein the first reinforcing member has an extension flange tightly contacting and connected to a portion of a side structure of a vehicle body, and
wherein the extension flange is connected to the reinforcing bead.

8. The vehicle rear structure according to claim 1, further comprising a second reinforcing member extending from the first reinforcing member toward a bottom of a vehicle body,
wherein the second reinforcing member is connected to the first reinforcing member to intersect at a predetermined angle.

9. The vehicle rear structure according to claim 8, wherein the second reinforcing member extends from the first reinforcing member to a wheel house of a side structure of the vehicle body.

10. The vehicle rear structure according to claim 9, wherein the second reinforcing member has:
an upper flange connected to the first reinforcing member; and
a lower flange connected to the wheel house.

11. The vehicle rear structure according to claim 10, wherein the first reinforcing member further includes a matching flange connected to at least a portion of an opening frame of a quarter inner panel in the side structure of the vehicle body, and
the opening frame defines a quarter opening of the quarter inner panel.

12. The vehicle rear structure according to claim 11, wherein the upper flange of the second reinforcing member is connected to the first reinforcing member and the opening frame of the quarter inner panel.
